(19) United States
(12) Patent Application Publication
(10) Pub. No.: US 2019/0055145 A1
(43) Pub. Date: Feb. 21, 2019

(54) In-line chlorinator for air conditioner drains

(71) Applicant: Michael Joseph Jeansonne, Belle Chasse, LA (US)

(72) Inventor: Michael Joseph Jeansonne, Belle Chasse, LA (US)

(21) Appl. No.: 15/651,104

(22) Filed: Aug. 21, 2017

(51) Int. Cl. C02F 1/50; F24F 13/22

(52) U.S. Cl. CPC C02F 1/50; C02F 2303/20; F24F 2013/228; F24F 13/222

(57) ABSTRACT

The Drain Free Applicator is an invention that prevents the buildup of mold and algae in pipes that drain condensation produced by evaporation coils within an air conditioning unit. This invention does so by holding treating tablets that are dissolved by the draining condensation and swept into the draining pipelines. This invention prevents the drain pan from filling up and overflowing with subsequent water damage to floors and ceilings. In newer units, it prevents triggering the water level sensor and shutting down the air conditioning unit.

### CROSS-REFERENCE TO RELATED APPLICATIONS

Currently, there are not any relevant applications that perform the same tasks as this.

### BACKGROUND OF THE INVENTION

The evaporator coils in an air conditioning unit produce condensation when warm air passes over them, and this condensation is collected in the drain pan. This drain pan has a drain line that allows the condensation to be drained to the building's waste lines or an outside drain. Mold and algae develop in these warm and humid conditions. This mold and algae cause blockages in the piping network which can cause the drain pan to overflow. If the drain pan over flows in an older air conditioning unit, floors or ceilings can suffer water damage, and in newer units, the safety switch will trip to shut down the air conditioning unit completely. Typically, on a regular basis, household bleach is poured down the open end of the in-line ventilation “tee” fitting to remove the mold and algae.

### BRIEF SUMMARY OF THE INVENTION

The Drain Free applicator is designed to prevent air conditioning drain lines from plugging due to mold and algae development. This is accomplished by allowing a canister of treating tablets in the drain line to constantly provide treating chemicals to prevent formation of algae and mold. The Drain Free applicator provides a safe, preventative system that can greatly reduce maintenance and is easily installed. It eliminates the process of having to deal with liquid bleach and the frequency that it needs to be applied.

### BRIEF DRAWING DESCRIPTION

The drawing illustrates the front, top, right, and isometric views of the applicator in FIGS. 1A, 1B, 1C, and 1D respectively. The drawings show how the invention is one continuous part that has two extended pipe fittings at the bottom for the applicator to be installed into a drain line with a diameter of ¾″. The canister section of the applicator has been dimensioned to 3″ to allow standard treating tablets to fit appropriately, but can be modified in manufacturing to allow for variations in tablet sizes. The same can be said for the ¾″ pipe fittings at the base of the applicator, as it is a common size in the piping used for draining the condensation; but variations can be made to adjust to different pipe networks.

A dust cap is optional. This cap is designed to be 3″ in diameter and be fitted atop the canister pictured in FIGS. 1A through 1D.

FIGS. 2A, 2B, 2C, and 2D illustrated the same models as 1A, 1B, 1C, and 1D respectively, but each figure has a threaded feature at the top of the canister section to allow for a low pressure installation where the Drain Free must be installed below the drain pan. This threaded cap can be seen in 3A and 3B.

### DETAILED DESCRIPTION OF INVENTION

Drain Free is designed to be installed in the ¾″ drain line leaving the air conditioner drain pan. The applicator should be installed so that the top of the canister is above the top of the drain pan.

The inlet and outlet are sized to fit onto ¾″ PVC pipe as depicted in FIGS. 1A, 1B, and 1D. Adaptors can be used to change the designed ¾″ fitting if the PVC piping used has a larger or smaller diameter. This patent would also allow for the resizing of further models of this applicator in the event that other sizes are used for these drain lines besides the dimensions given.

The unit is designed for standard 2⅝″ tablets to be loaded into the unit and provide a “time release” of treatment into the drain line to prevent the buildup of mold or algae. Depending on how much the AC unit is operating, four tablets should last a summer season. It is recommended for initial users to check the applicator monthly until a regular schedule can be determined based on the operation of the AC unit.

If the drain line has been installed for a while and no bleach has been poured into the line to remove mold or algae, pour one cup of household bleach into the Drain Free applicator before adding tablets.

Too many tablets or excessive length of unsupported, elevated drain line can cause the drain line to sag and keep water trapped in the Drain Free causing the tablets to dissolve and make the applicator less efficient. If the line sags too much it could allow water to spill out the top of the Drain Free onto the floor. In this event, a support, such as a section of 2×4 or other method, should be used to hold the Drain Free level in the drain line.

To install the Drain Free, cut out a length of the drain line equal to the length used by the Drain Free, (3.5″), and slide the cut ends of the drain line into the collar connections on the Drain Free to check for spacing. If spacing is okay and the drain line is not strained, pull the drain lines back out and apply PVC cleaner and PVC cement for the permanent installation.

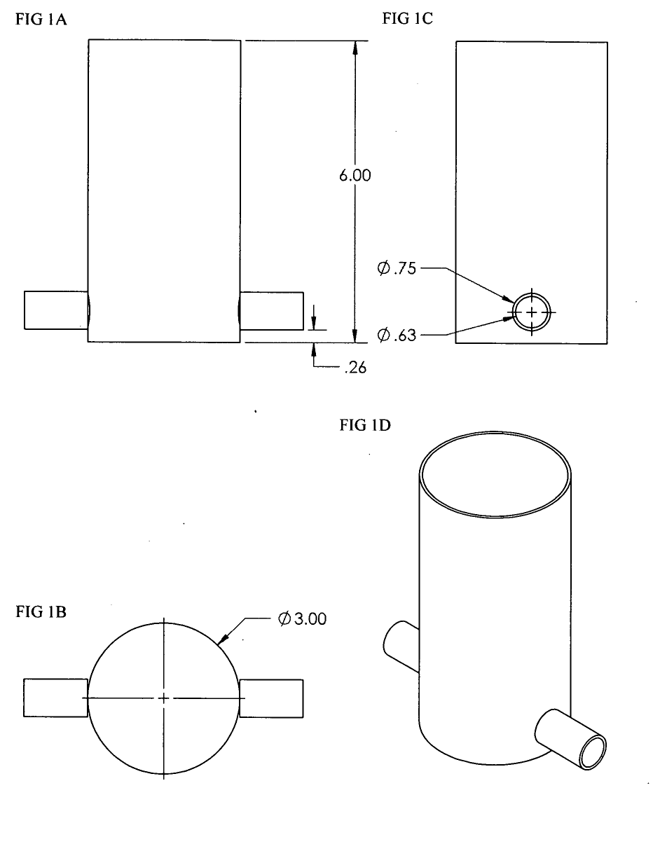

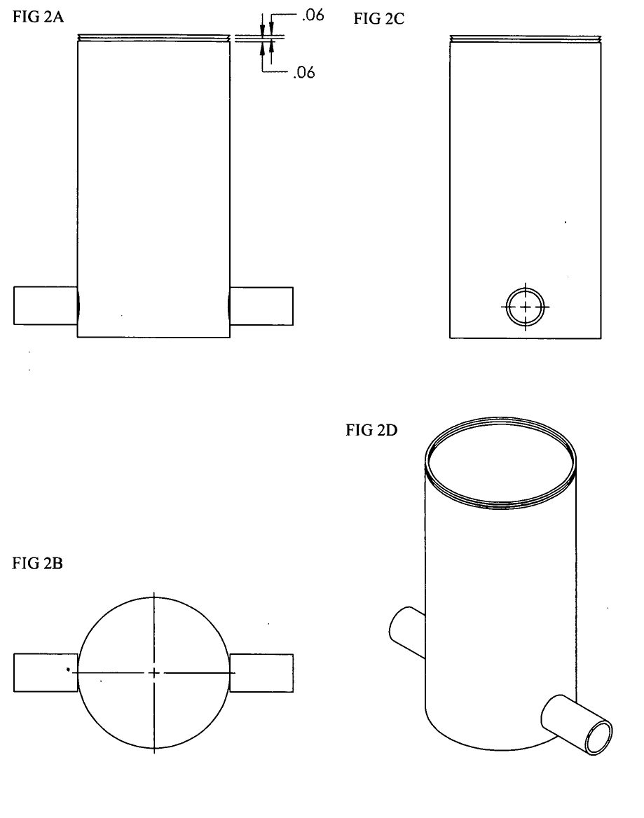

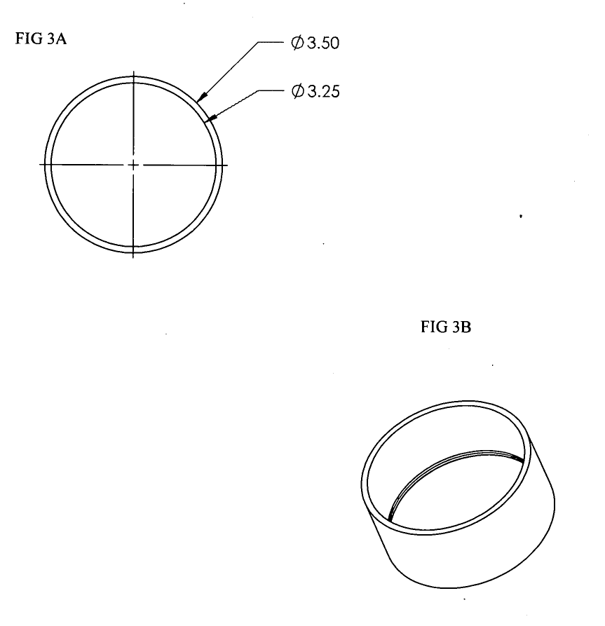

Once installed into the drain line and filled with treating tablets, the canister can optionally be covered with a fitted dust cap if needed; however, if the Drain Free has replaced the vertical ventilation “tee” fitting, holes should be drilled into the cap or the cap should be left off to allow for ventilation. A variation to the original design is depicted from FIGS. 2A to 3B to show the implementation of a threaded version of the design.

1. A device for holding treating tablets within a flow of drained condensation from an air conditioning unit. These tablets dissolve slowly preventing the buildup of algae and mold.

2. The invention in claim 1 further comprising of an inlet and outlet fitting.

3. The invention in claim 2 wherein the fittings have a set diameter of ¾″, but may be redesigned to fit drain line piping systems of different sizes.

4. The invention in claim 3 further comprising of a canister for holding tablets

5. The invention in claim 4 wherein the canister has a set diameter of 3″, but may be redesigned to contain other tablets of different sizes.

6. The invention in claim 5 further comprising of a capped assembly atop the canister.

7. The invention in claim 6 wherein the cap may be fitted or threaded to match the canister in order to hold pressure.
